(19) United States
(12) Patent Application Publication
(10) Pub. No.: US 2022/0241997 A1
(43) Pub. Date: Aug. 4, 2022

(54) HANDLE FOR A RAZOR

(71) Applicant: The Gillette Company LLC, Boston, MA (US)

(72) Inventor: Pu Xiao, Beijing (CN)

(21) Appl. No.: 17/572,868

(22) Filed: Jan. 11, 2022

(30) Foreign Application Priority Data
Jan. 29, 2021 (CN) 2021074316

(51) Int. Cl. B26B 21/52; B26B 21/22

(52) U.S. Cl. CPC B26B 21/522; B26B 21/222; B26B 21/528; B26B 21/521

(57) ABSTRACT

A handle for a razor having an elongated body portion at a distal end of said handle. At least a part of the elongated body portion is constructed from a material characterized by a flexural strength greater than 500 MPa and a Mohs hardness greater than 5.

### FIELD OF THE INVENTION

The invention relates generally to handles for razors, more particularly to a razor handle with an elongated body portion with improved mechanical properties.

### BACKGROUND OF THE INVENTION

Razors and electric shavers are used in wet environments by consumers for grooming purposes. Conventional razor handles have a handle for hand grasping and a head portion at a front end of which a razor head is mounted via an appropriate bearing structure. Various kinds of razor handles have gripping areas provided on a top surface of the handle been proposed in the past for improving hand grasping.

Razor handles are often made of molded plastics. A first plastic material may be used to mold a base of the handle and a second softer plastic, such as an elastomeric material, may be molded over the base. The second softer plastic material may include ribs or other gripping members to improve feel and reduce slipping, especially in a wet environment in which lotions, gels or oils are used. An example of a shaving razor having gripping portions is illustrated in U.S. Design Pat. No. D566,896 S.

One drawback of razor handles made of plastics such as ABS plastics is that plastic surfaces of such handles are easily scratched during daily usage and may also have indentations if dropped on harder surfaces. To improve scratch resistance and ease of cleaning, traditional ceramics have been used in razor handles. An example of a razor handle made of ceramic is described in U.S. Pat. No. 8,671,577B2 to Brown, Thomas A. (“U.S. Pat. No. 8,671,577”). However, razor handles made of traditional ceramics are brittle which means that they may be broken or fractured easily when the razor handle is dropped. Therefore, there remains a continuing need to provide a handle for razors with improved mechanical properties that improves durability and promotes reusability of the handle by consumers thereby offering a more sustainable alternative to disposable razors.

### SUMMARY OF THE INVENTION

The present invention relates to a handle for a razor, the handle comprising:
an elongated body portion at a distal end of said handle, wherein at least a part of the elongated body portion is constructed from a material characterized by a flexural strength greater than 500 MPa and a Mohs hardness greater than 5.

### BRIEF DESCRIPTION OF DRAWINGS

FIG. 1 is a front perspective view of a razor according to the present invention;

FIG. 2 is a partial perspective top view of an elongated body portion for a handle according to the present invention;

FIG. 3A is a front view of the outer member of the elongated body portion of FIG. 2;

FIG. 3B is a section view of the outer member of FIG. 3A;

FIG. 4 is a front perspective view of a handle according to the present invention;

FIG. 5 is a front perspective view of a comparative handle; and

FIG. 6 is a perspective of components of an alternative design of a razor according to the present invention.

### DETAILED DESCRIPTION OF THE INVENTION

Ergonomic design of parts making up a razor plays an important role in providing a superior shaving experience to the user during use of the razor. Specifically, design of a handle for a razor is key to providing a superior user experience. The design aspects may include improved structures, mechanical properties to maximize ruggedness, weight and/or shape configured for improved grasping and comfort qualities of the razor handle while shaving. It has been surprisingly found that a handle for a razor that comprises an elongated body portion constructed from a material characterized by a flexural strength greater than 500 MPa and a Mohs hardness greater than 5 can enhance the ergonomic qualities of the razor when shaving while improving durability of the razor, specifically, the hardness of the razor handle. Accordingly, providing a handle according to the present invention encourages the consumer to reuse the handle instead of throwing it away (which adds to waste) thereby developing a more sustainable and environment friendly shaving consumer habit.

Prior to describing the present invention in detail, the following terms are defined for clarity. Terms not defined should be given their ordinary meaning as understood by a skilled person in the relevant art.

The term “flexural strength” as used herein refers to a measurement of a physical property of a composite or material to resist bending deflection when energy is applied to a product made of the composite or material. In other words, flexural strength indicates how much force is required to break a test sample of a defined material and size. The higher the flexural strength value, the more impacting forces a material can withstand. It will be appreciated by a skilled person that the determination of flexural strength is determined based on the measurement method used and the material. For example, if the material is a rigid or semi-rigid plastic such as for example ABS, a standard test method for determining flexural strength of plastic may be ISO178. If the material is a monolithic ceramic, the standard test method for determining the monolithic ceramic is ISO14704:2008.

The term “hardness” as used herein refers to a measure of the resistance to localized plastic deformation induced by either mechanical indentation or abrasion. In general, different materials differ in their hardness; for example hard matter such as concrete, glass are harder than soft matter such as wood and common plastics such as ABS.

The term “Mohs hardness” as used herein refers to a qualitative ordinal scale characterizing scratch resistance of various minerals through the ability of harder material to scratch softer material, and is expressed in terms of a scale devised (1812) by the German mineralogist Friedrich Mohs. The term “Vickers hardness” refers to a measure of the hardness of a material calculated according to a Vickers hardness test. Vickers hardness may be used as the measure to determine the resistance to deformation, densification and fracture of ceramics and metals.

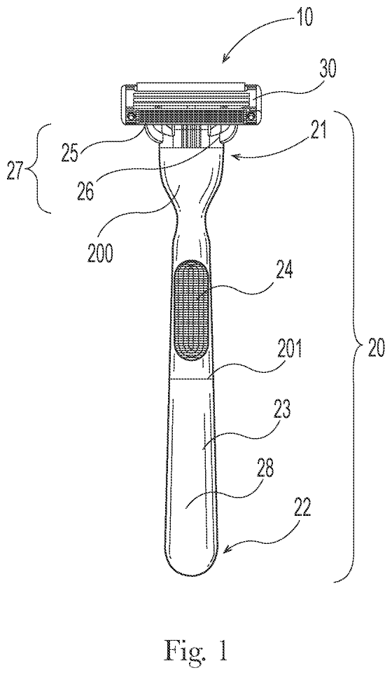

Referring to FIG. 1, a razor 10 of the present invention comprises a handle 20 and a blade cartridge unit 30, which may be releasably attached or be permanently attached to the handle 20 and contains one or more blades. The blade cartridge unit 30 may be a replaceable blade cartridge. The handle 20 may include a proximal end 21, a distal end 22, and an elongated body portion 23 at the distal end 22. The handle 20 may be of any suitable shape. The handle 20, for example, may be an elongated barrel shape or may be a contoured shape. Accordingly, a shape of the elongated body portion 23 may be adapted to correspond to the shape of the handle 20 to define a smooth, flush outer surface of the handle 20. However, it will be appreciated that the elongated body portion 23 may also be of any suitable size and shape if the design of the handle 20 does not require a smooth flush outer surface. For example, the elongated body portion 23 may comprise a curved surface, a flat surface, a surface with an irregular surface profile, or any combination thereof.

At least a part of the elongated body portion 23 is constructed from a material characterized by a flexural strength greater than 500 MPa and a Mohs hardness greater than 5. The value of the flexural strength and the Mohs hardness may range between the recited value and any of the values above the recited value.

The hardness of the elongated portion may provide advantages in scratch resistance and/or breakage resistance in the handle. In addition to being relatively harder than ABS, the elongated portion as discussed herein may also be relatively strong as the flexural strength may serve to avoid indentation and/or breakage on the handle if the handle is accidentally dropped.

A handle having the above flexural strength and Mohs hardness will be more robust relative to a handle made of common plastics due to the inherent problems in common plastic handles described hereinbefore. Accordingly, the handle according to the present invention is more likely to be reused again and therefore less waste is contributed to the environment.

The material of the elongated portion 23 may be characterized by a flexural strength of from 900 to 1350 MPa, and a Mohs hardness of from 6 to 9. The level of the flexural strength may range between any of these values inclusive of the recited values, and may comprise any value in the range listed above. The level of the Mohs hardness may also range between any of these values inclusive of the recited values and may comprise any value in the range listed above.

The material of the elongated portion 23 may be characterized by a flexural strength of from 900 MPa to 1350 MPa, from 900 MPa to 1200 MPa, from 900 MPa to 1100 MPa, from 900 MPa to 1000 MPa, from 1000 MPa to 1350 MPa, from 1000 MPa to 1200 MPa, from 1000 MPa to 1100 MPa, from 1100 MPa to 1200 MPa or different combinations of the upper and lower values described above or any combinations of any value in the ranges listed above.

The elongated body portion 23 may be of any suitable material that exhibits the aforementioned properties. It will be appreciated by a skilled person that Vickers hardness can also be used as an alternative measure for selecting a suitable material if the selected material is an engineering material, such as for example, reinforced glass, ceramic material, reinforced plastics, and combinations thereof. It is known that the Vickers hardness can be converted into a Mohs hardness of the suitable material and vice versa the Mohs hardness may also be converted to a Vickers hardness using standard calculation methods.

Specifically, the material of the elongated portion 23 may be a ceramic material that is relatively harder than traditional ceramics. It will be appreciated that Vickers hardness is a suitable unit of measure for engineering materials such as ceramics and therefore the elongated portion 23 may be characterized by a Vickers hardness greater than 700 kgf/mm². More specifically, the elongated portion 23 may comprise a Vickers hardness from 700 kgf/mm² to 1500 kgf/mm², from 950 kgf/mm² to 1350 kgf/mm², from 950 kgf/mm² to 1250 kgf/mm², from 950 kgf/mm² to 1110 kgf/mm², from 1110 kgf/mm² to 1350 kgf/mm², from 1110 kgf/mm² to 1250 kgf/mm², from 1250 kgf/mm² to 1350 kgf/mm² or different combinations of the upper and lower values described above or any combinations of any value in the ranges listed above.

The elongated body portion 23 may be constructed of a material selected from the group consisting of: zirconia, alkali-aluminosilicate glass, mixtures thereof, preferably zirconia.

Examples of material properties of the suitable zirconia materials are listed below in Table 1.

TABLE 1

| | | | Flexural strength | |
|---|---|---|---|---|
| | | | (MPA) based on | |
| | | | 4PB (4 Point | |
| | | | Bending) Test Method | |
| | Vickers | Approximate | for Determining | |
| Grade of | hardness/ | Mohs | Flexural strength | Density/ |
| Zirconia | kgf/mm² | hardness | (ISO 14704:2008) | g/mm³ |
| 2.1Y | 950-1100 | 6.5-7 | 900-1000 | 6.0-6.05 |
| 2.5Y | 1150-1250 | 7-9 | 1000-1100 | |
| 3Y | 1250-1350 | 9-10 | 1100-1200 | |

The elongated body portion 23 may be characterized by a front surface 28 with a decorative element thereon. Specifically, when the elongated body portion 23 is zirconia, the decorative element may be applied on at least a part of the front surface 28 by known surface decorative techniques including but not limited to glazing, decal label, physical vapor deposition (PVD) or the like. The decorative element may also be applied on an outer surface circumscribing the elongated body portion.

Referring to FIG. 1, the handle 20 may include a primary structural member 200 having a first arm 25 and a second arm 26 spaced apart from the first arm 25, the first and second arms 25, 26 defining a neck portion 27 of the handle 20 at the proximal end 21 of the handle 20. The two or more arms 25, 26 may be spaced apart from one another. The handle 20 may further include a gripping portion 24 at the proximal end 21 and adjacent the elongated body portion 23.

The gripping portion 24 may be made from any suitable material and/or designed for improving grip upon skin contact during use of the razor 10. The gripping portion 24 may be made, for example, from a polymer, an elastomer, a plastic, a thermoplastic, a rubber, any other suitable material, or any combination thereof. The gripping portion 24 may be made, for example, by molding, injection molding, insert injection molding, casting, extruding, any other suitable method, or any combination thereof. The elongated tubular body portion 23 and the grip portion 24 may have a total weight greater than 20 grams, preferably from 20 grams to 30 grams, for better tactile feel and handling during use or weight balancing when the razor 10 is placed in a stand.

The material of the elongated body portion 23 may have a higher density than that of the material(s) that form the grip portion 24, wherein said material preferably has a density of greater than or equal to 2 g/cm³.

Alternatively, the gripping portion 24 and the elongated body portion 23 may be separate parts which are designed to be assembled/coupled together to form the handle 20. The gripping portion 24 may be formed on a middle portion 201 of the primary structural member 200.

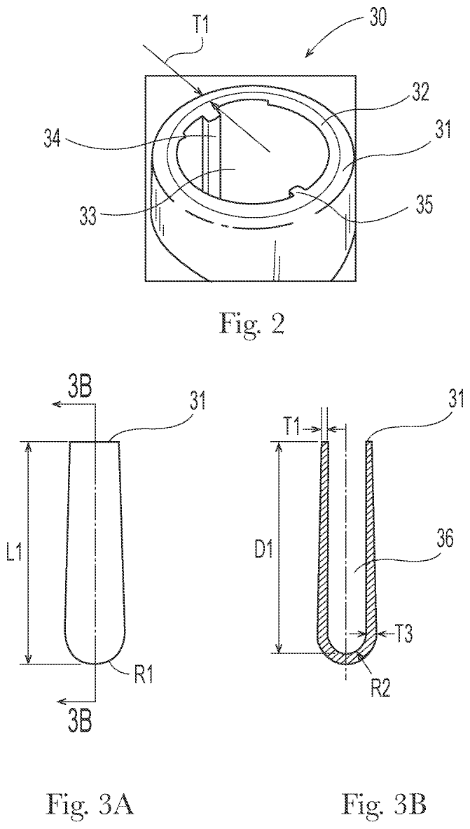

The elongated body portion 23 may be a unitary piece made of a material characterized by a flexural strength greater than 500 MPa and a Mohs hardness greater than 5. Alternatively, the elongated body portion 30 may be formed by two separate members, such as described hereinafter with reference to FIG. 2.

FIG. 2 is a partial perspective top view of an alternative design of an elongated body portion 30 for a handle according to the present invention. The elongated body portion 30 may be formed by two separate members, an outer member 31 and an insert 32 disposed in the outer member 31. The outer member 31 may be hollow with an outer member wall thickness T1, preferably T1 is less than or equal to 4.5 mm, more preferably from 4 mm to 4.5 mm or different combinations of the upper and lower values described above or any combinations of any value in the ranges listed above. Specifically, the outer member 31 may be made of a material similar to the material of the elongated body portion 23 described hereinbefore as the outer member 31 is in contact with external surfaces and the environment when in use. Specifically, the outer member 31 is characterized by a flexural strength greater than 500 MPa and a Mohs hardness greater than 5. The material may be characterized by a flexural strength of from 900 MPa to 1350 MPa. The material may be characterized by a Mohs hardness of from 6 to 9. The outer member 31 may be of any suitable material that exhibits the aforementioned properties. The outer member 31 may be constructed of a material selected from the group consisting of: zirconia, alkali-aluminosilicate glass, mixtures thereof, preferably zirconia.

The advantage of an outer member having a material of a flexural strength greater than 500 MPa and a Mohs hardness greater than 5 is that in addition to the advantages of being relatively hard and strong, the outer member 31 may also be relatively thin. This is particularly advantageous for razors which are designed to be of small form factor.

The insert 32 may be configured for connecting the primary structural member 200 and the outer member 31. The insert 32 may be made, for example, from a polymer, an elastomer, a plastic, a thermoplastic, metal, any other suitable material, or any combination thereof that is suitable for attaching to the primary structural member 200 and the outer member 31. The insert 32 may comprise a cavity 33 and one or more elongate rib members configured to position an engaging part of the primary structural member 200 in the cavity 33. As shown in FIG. 2, the insert 32 comprises the cavity 33 and first and second elongate rib members 34, 35 configured to position the engaging part of the primary structural member 200 in the cavity 33. The design and dimensions of the first and second elongate rib member 34, 35 may vary according to a design of corresponding positioning/mating features (not shown) of the engaging part of the primary structural member 200.

When the outer member 31 and the insert 32 are made of different materials, the outer member 31 and the insert 32 may be attached to each other by mechanical attachment means, chemical attachment means or a combination thereof. Chemical attachment means may include, but not limited to, chemical bonding, adhesive joining methods and combinations thereof.

FIG. 3A is a front view of the outer member 31 of the elongated body portion 30 of FIG. 2. FIG. 3B is a section view of the outer member 31 of FIG. 3A. Referring to FIG. 3A, the outer member 31 may be characterized by a length L1, and an outer radius R1 configured to define a surface profile at a distal end portion of the outer member 31. A wall thickness T1 of the outer member 31 may be uniform throughout the length L1 of the outer member 31. Alternatively, the outer member 31 may comprise a varying wall thickness along the length L1. The outer member 31 may comprise a top wall thickness T1 at a proximal end portion of the outer member 31, and a bottom wall thickness T3 at a distal end portion of the outer member 31. T1 may be configured to be less than T3, wherein an average of T1 and T3 is less than or equal to 5 mm, preferably less than or equal to 4.5 mm, more preferably less than or equal to 4 mm, even more preferably less than or equal to 3.5 mm Specifically, the outer member 31 comprises an interior 36 configured to receive the insert 32, wherein the interior 36 is characterized by a depth DE The depth D1 may corresponding to a length of the insert 32, and is less than or equal to L1. The interior 36 may further comprise an inner radius R2 configured to receive a mating surface of the insert 32.

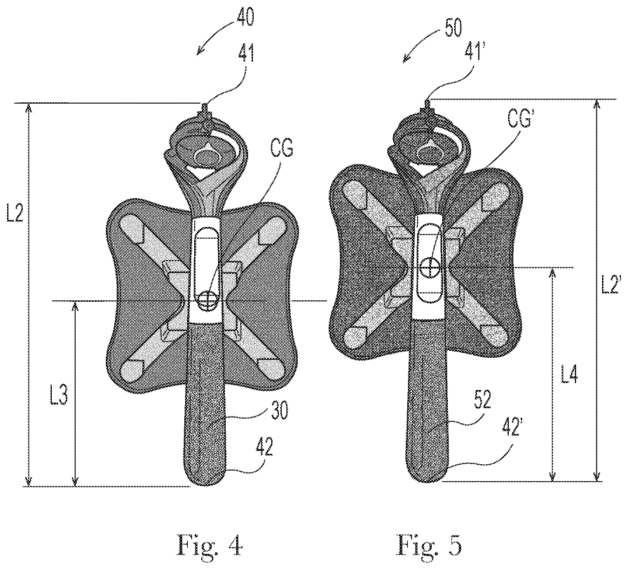

FIG. 4 is a front perspective view of a handle 40 according to the present invention. FIG. 5 is a front perspective view of a comparative handle 50. The handle 40 and the comparative handle 50 comprise substantially the same components and differ only in the construction of an elongated body portion as described hereinafter. The handle 40 has substantially the same features of the handle 20 of FIG. 1, and in particular comprises the elongated body portion 30 of FIG. 2. Referring to FIG. 5, the comparative handle 50 comprises an elongated body portion 52 having an outer member constructed from a plastic material that has a lower flexural strength and a lower Mohs hardness than the material of the elongated body portion 30 in the handle 40 of FIG. 4, and an inner member made of metal.

Each of the handle 40 and the comparative handle 50 is characterized by a handle length L2, L2′ extending between a proximal end 41, 41′ and a distal end 42, 42′ and a center of gravity (CG, CG′). The center of gravity is determined by performing the following steps:
a) placing the handle 40 and the comparative handle 50 on a platform 70 comprising a cross-shaped member 62 shown in FIGS. 4 and 5.
b) Each of the handle 40 and the comparative handle 50 are adjusted until each of the handle 40 and the comparative handle 50 are balanced on the cross-shaped member 72 or such that it does not tip over the platform 70
c) Measuring a C.G distance L3, L4 measured from the distal end 42, 42′ respectively to define a CG, CG′ of the handle 40 and the comparative handle 50.

It will be appreciated that any support structure can be modified for determining the center of gravity as long as there is a point contact between the handle and the support structure.

The above material compositions and characteristics of the inventive handle 40, and the comparative handle 50 are summarized in Table 2 below.

TABLE 2
Material Compositions and Characteristics

| | | | | C.G. | |
|---|---|---|---|---|---|
| | | | | Distance | |
| | | Elongated | | from | |
| | | Body Portion | | C.G. to | Ratio of C.G. |
| | | components/ | Handle | distal | Distance: |
| FIG. | Handle | material | Length | end | Handle Length |
| 4 | 40 | Elongated Body | L2 | L3 | L3:L2 |
| | | Portion 30 | (144.15 | (67.03 | 67.03:144.15 = |
| | | Total weight = | mm) | mm) | 0.47 |
| | | 25.75 grams | | | |
| | | Outer member 31 - | | | |
| | | Zirconia | | | |
| | | (Grade 2.1 Y from | | | |
| | | Table 1) | | | |
| | | Insert 32 - Plastic | | | |
| 5 | 50 | Elongated Body | L2′ | L4 | L4:L2′ = |
| | | Portion 52 | (144.15 | (77.81 | 77.81:144.15 = |
| | | Total Weight = | mm) | mm) | 0.54 |
| | | 15.49 grams | | | |
| | | Outer member - | | | |
| | | Plastic | | | |
| | | Insert - Metal | | | |

Specifically, the handle 40 may be characterized by a ratio of C.G. Distance from C.G. to distal end: Handle Length (L3:L2) of less than 0.50. The comparative handle 50 may be characterized by a ratio of L4:L2′ of greater than 0.50. An advantage of a razor handle having a ratio of L3:L2 less than 0.50 is that the handle 40 according to the present invention has a lower C.G. than the comparative handle 50. An advantage of having a lower C.G. for a handle 40 according to the present invention is that a razor comprising the handle 40 is better balanced and does not easily tip over when the razor is placed in a vertical position in a razor support stand. Further, a razor having a heavier weight at the distal end of the handle 40 could better balance a load distribution of the razor with a blade cartridge and blades because the chance of the handle 40 landing on the distal end 42 (where the outer member 31 is located) is increased. Specifically, when the razor comprising the handle 40 is inadvertently dropped during use, the elongated body portion 30 also acts as a buffer against impact. As the outer member 31 of the elongated body portion 30 is made of zirconia, the handle 40 would exhibit improved durability properties and is less prone to fracture upon impact on the floor and/or surfaces in an interior environment.

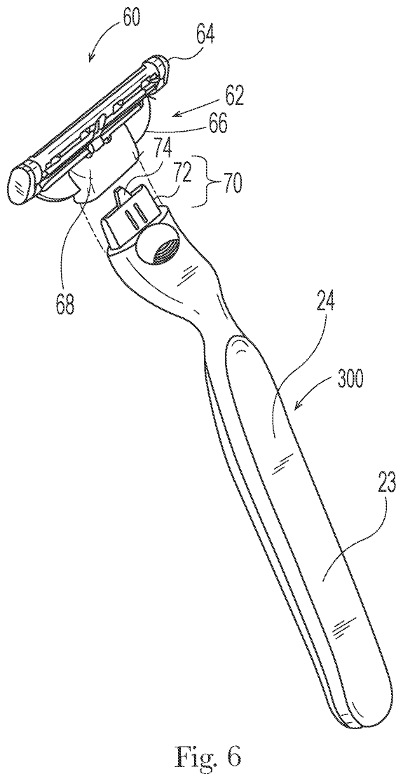

The elongated body portion may be integral with the gripping portion so as to form a unitary portion of the handle that is constructed of a single material selected from the group consisting of: zirconia, alkali-aluminosilicate glass, mixtures thereof, preferably zirconia. An exemplary example of a unitary portion of a handle 300 is shown in FIG. 6 described hereinafter.

FIG. 6 is a perspective of components of an alternative design of a razor 60 according to the present invention. The razor 60 has substantially the same features as the razor 20 and differs in that the razor 60 comprises a replaceable blade cartridge 62 and a handle 300 comprising an elongated body portion 23. The handle 300 may comprise a gripping portion 24 integral with the elongated body portion 23 so that the gripping portion 24 and the elongated portion 23 form a unitary portion of the handle 300 and is made of a single material. The handle 300 may be constructed of a material selected from the group consisting of: zirconia, alkali-aluminosilicate glass, mixtures thereof, preferably zirconia. The replaceable blade cartridge 62 comprises a housing 64 carrying one or more blades and an interconnect member 66 on which the housing 64 is pivotally mounted. The interconnect member 66 comprises a base structure 68 having a recess and is configured to be removably attached to a blade cartridge support structure 70 disposed on a primary structural member of the handle 300 for supporting a blade cartridge. The blade cartridge support structure 70 may comprise an extension member 72 on the handle 300. The base structure 68 may comprise an opening (not shown) at the top through which a spring-biased plunger 74 of the handle 300 passes to act on a cam surface (not shown) on the bottom of the housing 64. The base structure 68 may have a curved or beveled shape.

In another alternative design of a handle according to the present invention wherein the razor has a fixed blade cartridge, the handle 300 may configured for a razor with a non-replaceable or fixed blade cartridge, and modified such that the handle 300 does not have the extension member 72 and the biased plunger 74 wherein a gripping portion 24 is integral with the elongated body portion 23 so as to form a unitary handle made of a single material. The handle 300 may be constructed of a material selected from the group consisting of: zirconia, alkali-aluminosilicate glass, mixtures thereof, preferably zirconia.

The present invention also relates to a method of manufacturing a handle for a razor, the method comprising the steps of:

(a) providing an outer member, wherein the outer member is constructed from a material characterized by a flexural strength greater than or eu500 MPa and a Mohs hardness greater than 5;

(b) providing a primary structural structure comprising a blade cartridge support structure disposed on the primary structural member for supporting a blade cartridge;

(c) inserting an insert in the outer member to form an elongated body portion;

wherein the insert comprises a cavity having a cavity structure configured to position at least a portion of the primary structural member in the elongated body portion and the insert; and

(d) inserting the at least a portion of the primary structural member in the cavity wherein the primary structural member, the elongated tubular body portion and the insert form a handle for a razor.

The present invention may further comprise a method of assembling a replaceable blade cartridge to a reusable handle to form a razor, the method comprising:

(a) providing a handle (300) comprising an elongated body portion (23) at a distal end (22) of said handle (20) and coupled to the grip portion (24), wherein at least a part of the elongated body portion (23) is constructed from a material characterized by a flexural strength of greater than 500 MPa and a Mohs hardness of greater than 5, wherein the handle further comprises a blade cartridge support structure (70) extending from the proximal end (21) of the handle (20); wherein the blade cartridge support structure (70) is configured to releasably attach a replaceable blade cartridge (62) to the handle (300); and

(b) attaching a replaceable blade cartridge to the handle.

Representative embodiments of the present disclosure described above can be described as set out in the following paragraphs:

A. A handle (20) for a razor (10), the handle (20) comprising:
an elongated body portion (23) at a distal end (22) of said handle (20) and coupled to the grip portion (24), wherein at least a part of the elongated body portion (23) is constructed from a material characterized by a flexural strength of greater than 500 MPa and a Mohs hardness of greater than 5.
B. The handle (20) according to paragraph A, wherein said material is characterized by a flexural strength of 900 MPa to 1350 MPa.
C. The handle (20) according to paragraph A, wherein said material characterized by a Mohs hardness of 6 to 9.
D. The handle (20) according to paragraph (A), wherein the handle (20) comprises (i) a grip portion (24) at a proximal end (21) of said handle (20).
E. The handle (20) according to paragraph D, wherein said material has a higher density than that of the material(s) that form the grip portion (4), wherein said material preferably has a density of greater than 2 g/cm³.
F. The handle (20) according to paragraph (A), wherein said material is selected from the group consisting of: zirconia, alkali-aluminosilicate glass, and a mixture thereof, wherein said material preferably comprises zirconia.
G. The handle (20) according to paragraph (A), wherein the elongated body portion (23) is a unitary piece made from the material.
H. The handle (20) according to paragraph (A), wherein the elongated body portion (23) is hollow with a wall thickness (T1) of less than 4.5 mm.
I. The handle (20) according to paragraph (A), wherein the handle (20) have a total weight of greater than 20 grams, preferably from 20 grams to 30 grams.
J. The handle (20) according to paragraph (A), wherein the handle (20) is characterized by a handle length (L2) extending between the proximal end (21) and the distal end (22) and a center of gravity (CG) located at a distance (L3) measured from the distal end (22), wherein L3:L2 is less than 0.50.
K. The handle (20) according to paragraph (A), wherein the elongated body portion (23) has a front surface with a decorative or textured element thereon.
L. The handle (300) according to paragraph (A), further comprising a blade cartridge support structure (70) extending from the proximal end (21) of the handle (20); wherein the blade cartridge support structure (70) is configured to releasably attach a replaceable blade cartridge (62) to the handle (300).
M. A razor (10, 60) comprising a handle (20, 300) according to paragraph A.
N. A method of manufacturing a handle for a razor, the method comprising the steps of:

(a) providing an outer member, wherein the outer member is constructed from a material characterized by a flexural strength greater than 500 MPa and a Mohs hardness greater than 5;

(b) providing a primary structural structure comprising a blade cartridge support structure disposed on the primary structural member for supporting a blade cartridge;

(c) inserting an insert in the outer member to form an elongated body portion;

wherein the insert comprises a cavity having a cavity structure configured to position at least a portion of the primary structural member in the elongated body portion and the insert; and

(d) inserting the at least a portion of the primary structural member in the cavity wherein the primary structural member, the elongated tubular body portion and the insert form a handle for a razor.

O. A method of assembling a replaceable blade cartridge to a reusable handle to form a razor, the method comprising:

(a) providing a handle according to paragraph L; and

(b) attaching a replaceable blade cartridge to the handle.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” .

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A handle for a razor, the handle comprising:
an elongated body portion at a distal end of said handle, wherein at least a part of the elongated body portion is constructed from a material characterized by a flexural strength of greater than 500 MPa and a Mohs hardness of greater than 5.

2. The handle according to claim 1, wherein said material is characterized by a flexural strength of 900 MPa to 1350 MPa.

3. The handle according to claim 1, wherein said material characterized by a Mohs hardness of from 6 to 9.

4. The handle according to claim 1, wherein the handle comprises (i) a grip portion at a proximal end of said handle.

5. The handle according to claim 4, wherein said material has a higher density than that of the material(s) that form the grip portion, wherein said material preferably has a density of greater than 2 g/cm³.

6. The handle according to claim 1, wherein said material is selected from the group consisting of: zirconia, alkali-aluminosilicate glass, and a mixture thereof, wherein said material preferably comprises zirconia.

7. The handle according to claim 1, wherein the elongated body portion is a unitary piece made from the material.

8. The handle according to claim 1, wherein the elongated body portion is hollow with a wall thickness (T1) of less than 4.5 mm.

9. The handle according to claim 1, wherein the handle have a total weight of greater than 20 grams, preferably from 20 grams to 30 grams.

10. The handle according to claim 1, wherein the handle is characterized by a handle length (L2) extending between the proximal end and the distal end and a center of gravity (CG) located at a distance (L3) measured from the distal end, wherein L3:L2 is less than 0.50.

11. The handle according to claim 1, wherein the elongated body portion has a front surface with a decorative or textured element thereon.

12. The handle according to claim 1, further comprising a blade cartridge support structure extending from the proximal end of the handle; wherein the blade cartridge support structure is configured to releasably attach a replaceable blade cartridge to the handle.

13. A razor comprising a handle according to claim 1.

14. A method of manufacturing a handle for a razor, the method comprising the steps of:
(a) providing an outer member, wherein the outer member is constructed from a material characterized by a flexural strength greater than 500 MPa and a Mohs hardness greater than 5;
(b) providing a primary structural structure comprising a blade cartridge support structure disposed on the primary structural member for supporting a blade cartridge;
(c) inserting an insert in the outer member to form an elongated body portion;
wherein the insert comprises a cavity having a cavity structure configured to position at least a portion of the primary structural member in the elongated body portion and the insert; and
(d) inserting the at least a portion of the primary structural member in the cavity wherein the primary structural member, the elongated tubular body portion and the insert form a handle for a razor.

15. A method of assembling a replaceable blade cartridge to a reusable handle to form a razor, the method comprising:
(a) providing a handle according to claim 12; and
(b) attaching a replaceable blade cartridge to the handle.
